(19) United States
(12) Patent Application Publication
(10) Pub. No.: US 2021/0381135 A1
(43) Pub. Date: Dec. 9, 2021

(54) MELT-DRAWN POLYAMIDE FILAMENTS

(71) Applicant: Evonik Operations GmbH, Essen (DE)

(72) Inventors: Lan de Gans Li, Mülheim an der Ruhr (DE); Martin Wielpütz, Senden (DE); Markus Hartmann, Sendenhorst (DE); Dirk Heinrich Bücker, Ratingen (DE)

(73) Assignee: Evonik Operations GmbH, Essen (DE)

(21) Appl. No.: 17/281,927

(22) PCT Filed: Oct. 9, 2019
(86) PCT No.: PCT/EP2019/077341

§ 371 Date: Mar. 31, 2021

(30) Foreign Application Priority Data
Oct. 10, 2018 (EP) 18199730.5

(51) Int. Cl. D02J 1/22; D01F 6/60; D01D 10/02; C08G 69/26; C08G 69/14; C08G 69/10

(52) U.S. Cl. CPC D02J 1/224; D01F 6/60; C08G 69/10; C08G 69/26; C08G 69/14; D01D 10/02

(57) ABSTRACT

Stretched filaments based on linear, branched or cyclic, aliphatic or semiaromatic polyamides, wherein the filaments have been stretched at a temperature between glass transition temperature and melting point and wherein the filaments are cooled down to room temperature under full tensile load.

### CROSS REFERENCE TO RELATED APPLICATIONS

This application is a 35 U.S.C. § 371 U.S. national phase entry of International Application No. PCT/EP2019/077341 having an international filing date of Oct. 9, 2019, which claims the benefit of European Application No. 18199730.5 filed Oct. 10, 2018, both of which are incorporated herein by reference in its entirety.

### FIELD

The present invention is directed to stretched filaments based on linear, branched or cyclic, aliphatic or semiaromatic polyamides, wherein the filaments had been stretched at a temperature between glass transition temperature and melting point, and wherein the filaments are cooled down to room temperature under full tensile load.

### BACKGROUND

Fiber-reinforced materials are usually based on the use of glass fibers or carbon fibers in polymers. This means that there is the fundamental problem of the compatibility of the fibers with the matrix material and hence binding problems between reinforcing material and matrix.

This is frequently a particular problem when thermoplastics are used as matrix. Moreover, these materials are not recyclable since it is very difficult to separate the fibers out.

The prior art discloses predominantly two methods of stretching polyolefins, such as polyethylene or polypropylene, the melt spinning method (WO 2004/028803 A1) and the gel spinning method (WO 2010/057982 A1). Polyolefins can simply be stretched at room temperature, it being necessary to select a relatively low stretching speed owing to the exothermicity of stretching. The stretched polyolefins have the disadvantage that they shrink very significantly after stretching when processed at elevated temperatures and therefore first have to be equilibrated at the desired working temperature. Moreover, stretched polyolefins have very limited mechanical values that limit their usability as reinforcing fibers. Particularly the lack of thermal stability and lack of compressive stress (cold formability) are disadvantageous.

DE 766441 and GB 598820 claim an improvement in mechanical values of stretched polyamide wires by controlled shrinkage, for example with the aid of water or water vapor. However, shrinkage processes are disadvantageous for the purpose of the present invention. What is more particularly shown is the adverse effect of water in relation to tear resistance.

WO 2013/190149 A1 discloses ductile fibers of various thermoplastics, preferably polypropylene and polyethylene, as a constituent of what are called prepregs. These are understood to mean weaves of thermoplastic fibers with brittle fibers, in particular carbon fibers. These materials are then preferably thermoformed or compressed in a matrix of the material of the ductile fibers. This melts the ductile fibers and leads to an improvement in the binding between matrix and brittle fiber.

The production of fully aromatic polyamide fibers, such as poly(p-phenyleneterephthalamide) (PPTA, aramid under the following brand names: Kevlar® (trademark of DuPont, USA), Twaron® (trademark of Teijin Lim, Japan)), is described in U.S. Pat. No. 3,869,430 A. These fibers are produced by what is called the wet spinning method from a sulfuric acid solution. This method is costly, technically difficult and harmful to the environment.

In WO 2015/107024 A1, semiaromatic polyamides are stretched with a stretching factor of below 5; the stretching temperatures are preferably just below the glass transition temperature. Any shrinkage can be counteracted by heating the stretched filaments to as high as possible a level under tensile load, this temperature being above the stretching temperature. This means that the filaments thus have to be heated twice.

U.S. Pat. No. 3,393,252 discloses mixtures of two non-isomorphous polyamides, the glass transition temperatures of which must be below 120° C. and above 140° C., which are used for stabilization of tyres.

In U.S. Pat. No. 5,011,645, fibers are produced by a process in which the tow is first drawn between multiple feed rolls and draw rolls, followed by heating and cooling of the tensile filaments in order to anneal them under controlled tension.

The term “filament” in the context of this invention is understood to mean fibers, films or ribbons. Preferred filaments are films or ribbons. Films in particular are preferably stretched in more than one direction. Preferably, the filaments have an aspect ratio greater than 2, more preferably of greater than 10, even more preferably of greater than 50 and particularly preferably greater than 100. The aspect ratio is defined as the ratio of width to thickness, where the length is more than 5 times, preferably more than 10 times, more preferably more than 100 times and especially more than 1000 times the width. Particular preference is given to what are called continuous filaments having, for example, a length of 10 meters or more.

### SUMMARY

The problem addressed by the present invention was therefore that of producing stretched filaments from aliphatic or semiaromatic thermoplastics, and of providing a non-hazardous, simple and solvent-free method of stretching polyamide.

The problem was solved by stretched filaments of polyamide, wherein the filaments are cooled down under full tensile load after the stretching.

### DETAILED DESCRIPTION

The present invention provides stretched filaments containing at least 80% by weight of, preferably 85% by weight of, more preferably 90% by weight of, more preferably still 95% by weight of, and especially consisting of linear, branched or cyclic, aliphatic or semiaromatic polyamides,

wherein the dry filaments have been stretched at a temperature between glass transition temperature and melting point and

wherein the filaments have been cooled down in the dry state to below 100° C. under full tensile load.

The invention further provides a process for producing the stretched filaments according to the invention.

The invention further provides for the use of the stretched filaments according to the invention for production of composites.

The invention further provides for the use of the stretched filaments according to the invention for production of winding layers.

One advantage of the stretched filaments according to the invention is that they undergo little shrinkage at elevated temperature, i.e. have barely any relaxation effect.

It is also advantageous that the stretched filaments according to the invention have high mechanical stability. The mechanical stability is preferably measured in the form of a strength at break in the direction of stretching. In addition, the maximum strength prior to breaking may be measured.

It is also advantageous that the stretched filaments according to the invention have high mechanical stability, even at elevated temperature.

The stretched filaments according to the invention, the composites according to the invention comprising the filaments according to the invention, and the production and use according to the invention are described by way of example hereinafter, without any intention that the invention be restricted to these illustrative embodiments. When ranges, general formulae or classes of compounds are specified below, these are intended to encompass not only the corresponding ranges or groups of compounds which are explicitly mentioned but also all subranges and subgroups of compounds which can be obtained by leaving out individual values (ranges) or compounds. Where documents are cited within the context of the present description, the entire content thereof is intended to be part of the disclosure of the present invention. Where percentage figures are given hereinafter, unless stated otherwise, these are figures in % by weight. In the case of compositions, the percentage figures are based on the entire composition unless otherwise stated. Where average values are given hereinafter, unless stated otherwise, these are mass averages (weight averages). Where measured values are given hereinafter, unless stated otherwise, these measured values were determined at a pressure of 101 325 Pa and at a temperature of 25° C.

The scope of protection includes finished and packaged forms of the products according to the invention that are customary in commerce, both as such and in any forms of reduced size, to the extent that these are not defined in the claims.

The polyamides are preparable by a combination of diamine and dicarboxylic acid, from an ω-aminocarboxylic acid and/or the corresponding lactam. In this case, the ω-aminocarboxylic acid or the lactam or a mixture of different monomers of this kind contains an arithmetic average of preferably at least 7.0 carbon atoms. For a combination of diamine and dicarboxylic acid, the arithmetic average of the carbon atoms of diamine and dicarboxylic acid is preferably at least 7.0. Suitable polymers according to the invention are PA 6.9 (preparable from hexamethylenediamine [6 carbon atoms] and nonanedioic acid [9 carbon atoms]; the average of the carbon atoms in the monomer units here is thus 7.5), PA 6.8, PA 6.10, PA 6.12, PA 6.13, PA 6.14, PA 6.18, PA 10.6, PA 10.10, PA 10.12, PA 12.12, PA 10.13, PA 10.14, PA 11, PA 12, PA 6.T, PA 9.T, PA 10.T, PA 12.T, PA 14.T, PA PACM.10 (PACM=4,4′-diaminocyclohexylmethane), PA PACM.12, PA MACM.10 (MACM=3,3′-dimethyl-4,4′-diaminocyclohexylmethane), PA MACM.12, PA TMD.10 (TMD=1,6-diamino-2,4,4-trimethylhexane, 1,6-diamino-2,2,4-trimethylhexane), PA TMD.12 and generally polyamides that derive from a diamine and nonadecanedioic acid. Also suitable are copolyamides; the diamine and dicarboxylic acid, w-aminocarboxylic acid and lactam units mentioned can be combined here as desired. In addition, polyetheramides and polyetheresteramides based on these polyamides are also suitable in accordance with the invention. Polyetheramides are formed from dicarboxylic acid-regulated polyamide blocks and polyetherdiamine blocks, and polyetheresteramides correspondingly from dicarboxylic acid-regulated polyamide blocks and polyetherdiol blocks. The polyether units contain generally 2 to 4 carbon atoms per ether oxygen. Polyetheramides and polyetheresteramides are known to those skilled in the art and are commercially available in a multitude of types.

Preferably, the polyamides in the monomer units contain an arithmetic average of not more than 40 and more preferably not more than 26 carbon atoms.

The polyamides preferably do not contain any solvents.

The term “dry” means that the filaments are not brought into contact with a liquid, especially not with water. The filaments thus preferably have a maximum of 1.5% by weight of water, more preferably a maximum of 1% by weight, especially a maximum of 0.9% by weight. The water content is determined by standard prior art methods, preferably according to Karl Fischer with a coulometer. A suitable example is the Metrohm KF 831 coulometer; a suitable oven temperature is 170° C.

The minimum stretching temperature Tstr,min is preferably determined with the aid of equation (1):

T_{str,min}=((Tₘ−T_{g})*X_{c})+T_{g} (G1)

where Tₘ=melting point, T_{g}=glass transition temperature and X_{c} is the crystallinity, and wherein the crystallinity is determined by equation (2)

$${X}_{C} = \frac{Δ {H}_{m}}{Δ {H}_{m}^{0}} , \qquad ( G2 )$$

The parameters Tₘ, T_{g} and ΔHₘ within the scope of the present invention are determined with the aid of DSC, preferably according to EN ISO 11357-1:2016D, more preferably as described in the examples.

The values ΔHₘ⁰ for calculation of the crystallinity X_{c} are taken from standard tabular works, for example van Krevelen “Properties of Polymers”, 4th edition, 2009. The following values are preferably assumed:

| Polyamide | ΔHₘ⁰ | T_{g} | Tₘ |
|---|---|---|---|
| PA 6 | 230 | 40 | 260 |
| PA 11 | 226 | 46 | 220 |
| PA 12 | 210 | 37 | 179 |
| PA 6.6 | 300 | 50 | 280 |
| PA 6.10 | 260 | 50 | 233 |
| PA 6.12 | 215 | 54 | 200 |
| PA 10.9 | 250 | | 214 |
| PA 10.10 | 200 | 60 | 216 |

The values relate to the polyamide of the unstretched filaments, in the 2nd heating in the DSC.

At a crystallinity of 0 and close to 0, the stretching temperature is at least 5° C. above the glass transition temperature. At a crystallinity of 1 and close to 1, the stretching temperature is at least 5° C. below the melting temperature.

Preferably, the filaments according to the invention are stretched at a temperature above the minimum stretching temperature T_{str,min}, more preferably at a stretching temperature defined according to equation (G3)

T_{str.}=((Tₘ−T_{str,min})* [symbol] )+T_{str,min} (G3)

where [symbol] is a value of 0.05 to 0.95, preferably 0.1 to 0.8, more preferably 0.2 to 0.7, especially preferably 0.3 to 0.6.

The filaments according to the invention have preferably been stretched by a stretching factor SF of not less than 2.5, more preferably not less than 5, even more preferably SF not less than 10, especially preferably not less than 15 or greater.

The filaments according to the invention have preferably been stretched in free space without contact. The zone in which the stretching takes place is a zone in which the atmosphere of the environment is heated, i.e., for example, a type of furnace, tubular furnace or the space between two heated plates.

The filaments according to the invention can be stretched continuously or batchwise.

Preference is given to static stretching, i.e. stretching operations in which one end of the filament remains at rest with speeds of 10 mm/min up to 200 mm/min, preferably of 20 mm/min up to 100 mm/min, more preferably 30 mm/min to 80 mm/min.

Preferred continuous stretching operations are conducted in such a way that the low transport rate is preferably in the range from 5 mm/min up to 20 000 mm/min, preferably from 10 mm/min up to 3000 mm/min, further preferably from 50 mm/min up to 2500 mm/min, more preferably 100 mm/min to 2000 mm/min, even more preferably 500 mm/min to 1500 mm/min. The stretching factors are used to calculate the speed of the faster-running transport unit.

The filaments according to the invention can be stretched by just one stretching operation or by several in succession. In the latter case, the stretching temperature chosen has to be higher. Just one stretching operation is more preferred.

The filaments according to the invention are cooled down to below 100° C. after the stretching operation. This cooling is preferably effected gradually, preferably for at least 1 second, more preferably at least 5 seconds, even more preferably at least 10 seconds, more preferably at least 30 seconds, especially preferably at least 1 minute.

Water cooling of the stretched filaments is ruled out. The stretched filaments are preferably not exposed to water in any state of matter, which explicitly excludes steam, and even departure from standard conditions, especially the use of different pressures to generate different states of matter of water, is ruled out.

The stretched filaments according to the invention preferably have only minor shrinkage/relaxation in the direction of tension when heated to a temperature below the melting point.

Preferably, the relaxation temperature is above the glass transition temperature and below the melting temperature, preferably below the stretching temperature.

Preferably, the filaments according to the invention relax by a maximum of 6% in relation to the stretched length, preferably by a maximum of 5.5%, more preferably by a maximum of 5%, even more preferably by a maximum of 4.5% and especially preferably by a maximum of 4%.

More preferably, the filaments according to the invention relax at a relaxation temperature of 80° C. by a maximum of 6% in relation to the stretched length, preferably by a maximum of 5.5%, more preferably by a maximum of 5%, even more preferably by a maximum of 4.5% and especially preferably by a maximum of 4%.

Preferably, the relaxation of the filaments according to the invention is not effected under tensile stress.

The stretched filaments according to the invention preferably have a length greater than 5 times a dimension at right angles to the length; the filaments are preferably what are called endless filaments. The length of the filaments is always determined in the direction of tension.

The term “filament” in the context of this invention is understood to mean fibers, films or ribbons. Films in particular are preferably stretched in more than one direction.

The individual filaments can be worked to form composites such as filament bundles; thus, preferred composites of fibers are fiber bundles and yarns. The filament bundles, including fiber bundles or yarns, can be processed to give further composites, preferably to give uni- or multidirectional scrims, weaves such as mats, and knits, or else mixed forms.

Scrims may consist either of filaments cut to a particular length or of endless filaments in the form of windings around tubes, for example.

Preferred scrims composed of endless filaments are winding layers around hollow bodies. They are preferably unidirectional or multidirectional. Multidirectional winding layers have an angle in relation to the direction of tension of the filaments. This angle is preferably in the range from 5° to 120°, more preferably from 30° to 90°, especially preferably 15° to 80°. In the case of winding layers around tubes, these winding wires have a slope angle in relation to the centre of the tube. Preferably, different winding layers have different slope angles. Preferably, the winding layers around tubes are designed in relation to the slope angle such that, after a rotation, the edges of the layer conclude flush with one another.

### BRIEF DESCRIPTION OF THE DRAWINGS

FIG. 1 shows graphs of the results according to table 1; and

FIG. 2 shows a plot of maximum strength, δm [MPa] against temperature at which δm was determined for the samples.

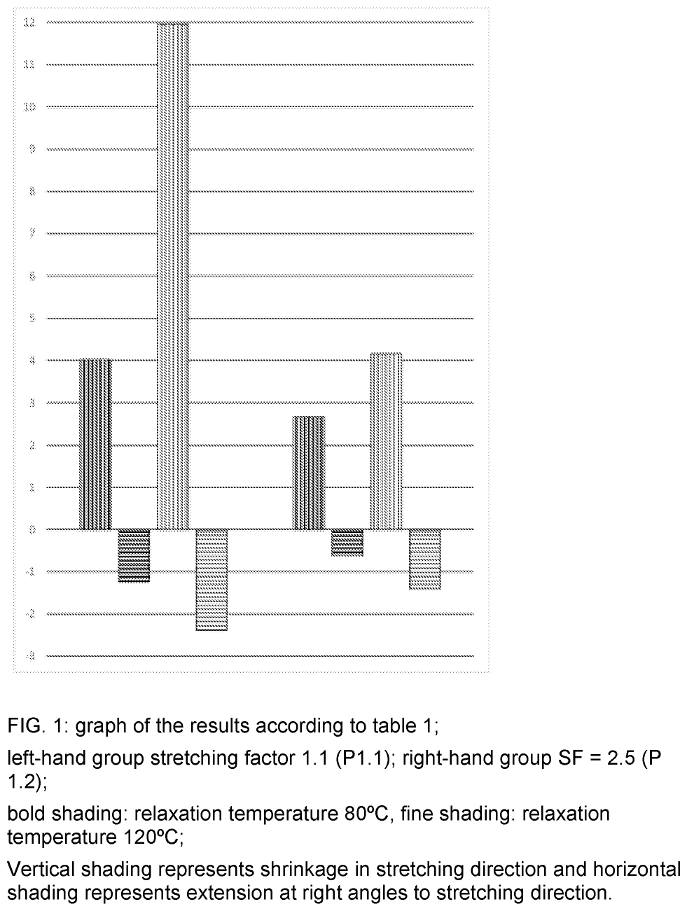

FIG. 1: graph of the results according to table 1;
left-hand group stretching factor 1.1 (P 1.1); right-hand group SF=2.5 (P 1.2);
bold shading: relaxation temperature 80° C., fine shading: relaxation temperature 120° C.;
Vertical shading represents shrinkage in stretching direction and horizontal shading represents extension at right angles to stretching direction.

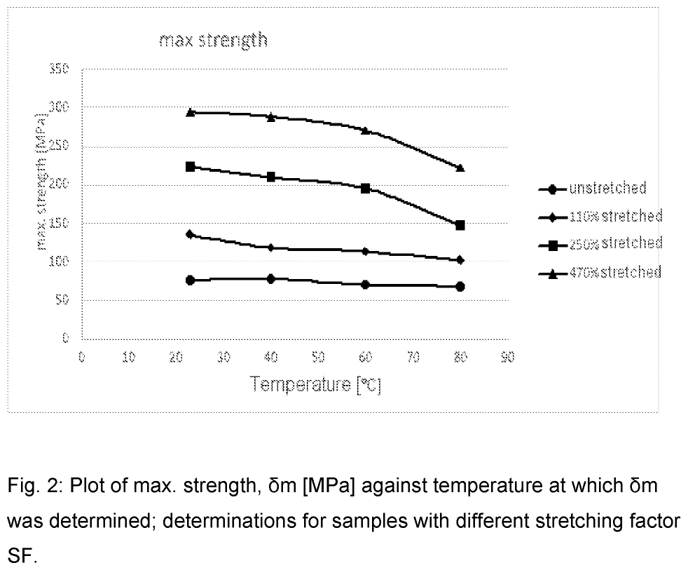

FIG. 2: Plot of max. strength, σₘ [MPa] against temperature at which σₘ was determined;
determinations for samples with different stretching factor SF.

### EXAMPLES

Materials

PA 6.10: VESTAMID Terra HS 16 (Evonik)

PA 10.10: VESTAMID Terra DS 18 (Evonik)

PA 12: VESTAMID L2101 nf (Evonik)

Trogamid: CX7323 (Evonik)

PA 11

Methods

DSC:

Perkin Elmer, Diamond type, automatic peak recognition and integration, in accordance with DIN EN ISO 11357-1:2010, heating rate 20 K/min.

### Example 1, Production of the Specimens

The abovementioned polyamides were extruded by means of an extruder (Collin E45M) at a temperature of 5 to 10° C. above the melting point (for example at 250-260° C. for PA 12) to give a ribbon having a thickness of 150, 350 and 650 μm, and cooled to 30-40° C.

The ribbons were calendered at a speed of 1.4 m/min; the width was 35 mm.

P 1.* are samples of PA 12;

P 2.* are samples of Trogamid;

P 3.* are samples of PA 6.10;

P 4.* are samples of PA 10.10;

P5.* are samples of PA 11.

### Example 2, Stretching of the Specimens

Method 1:

In a tensile tester (Zwick, Z101-K), specimens according to Example 1 were stretched at a speed of 50 mm/min at 140° C. Before the tensile stress was released, the specimens were cooled down to room temperature. The cooling was conducted slowly within 2 min or quickly within 10 sec. Further samples according to the following table:

| | P 1.0 | P 1.3 | P 2.0 | P 2.1 | P 3.0 | P 3.1 | P5.0 | P5.1 |
|---|---|---|---|---|---|---|---|---|
| Stretching factor | 1 | 5 | 1 | 4.5 | 1 | 4.6 | 1 | 4.6 |
| Stretching speed | | 50 | | 50 | | 25 | | 25 |
| [mm/min] | | | | | | | | |
| Stretching | | 140 | | 60 | | 80 | | 60 |
| temperature [° C.] | | | | | | | | |
| Cooling [min] | | 2 | | 2 | | 2 | | 2 |

Method 2:

An endless specimen according to Example 1 was provided on a coil, and stretched on a continuous machine (Retech Drawing) at a material feed rate of 1 to 2.5 rpm and a tension rate of up to 32 rpm to a stretching factor (SF) of 3.5 to 8. The stretching took place at a temperature of 60 to 140° C.

Example 0: Continuous stretching process—samples P 1,* (PA12), thickness 650 μm, width 10 mm.

| | P 1.5 | P 1.6 | P 1.7 | P 1.8 |
|---|---|---|---|---|
| Stretching | 3.5 | 5 | 6.6 | 8 |
| factor | | | | |
| Stretching | 130 | 80 | 60 | 140 |
| temperature | | | | |
| [° C.] | | | | |
| Speed of | 2.5 | 2.5 | 2.5 | 1 |
| the first roll | | | | |
| Speed of | 8.75 | 12.50 | 16.5 | 8 |
| the last roll | | | | |

### Example 3, Relaxations

Specimens from Example 2 were cut to a length of 10 cm. The specimens according to Example 2, Method 1, were cut at both ends. The specimens were stored in a thermal oven without tensile load, individually lying horizontally in a freely mobile manner, at temperatures of 80° C. and 120° C. for 5 h.

After cooling, the two areal dimensions of the samples were measured. The results are shown in Table 1 and FIG. 1.

Table 1, relative change in the dimensions of the specimens according to Example 3, length=in direction of tension, width=90° to the direction of tension

| | | | |
|---|---|---|---|
| Length | Width | Length | Width |

| | | |
|---|---|---|
| Sample | 80° C. | 120° C. |

| | | | | |
|---|---|---|---|---|
| P 1.1; RF = 1.1 | −4.03 | +1.23 | −11.96 | +2.38 |
| P 1.2; RF = 2.5 | −2.67 | +0.61 | −4.17 | +1.39 |

Polyamide samples have low relaxation and surprisingly show increasingly lower relaxation with rising stretching factor.

### Example 4, Mechanical Tests

Tensile Tests

Dumbbell specimens according to DIN 527-5:1997 (A specimen) were punched out of the stretched ribbons; the thickness was the result of the stretching experiment and was not altered. The tensile strength was measured on 3 specimens in each case by means of a Zwick tensile tester at different temperatures. Testing speed=5 mm/min, clamped length=120 mm and measurement length of the incremental gauge=75 mm.

Temperature 23° C., relative humidity 50%.

The results are reported in Tables 2 and 3, and FIG. 2.

The results are the arithmetic average from 3 specimens.

TABLE 2
T = 23° C., results from the tensile test according to Example 4.

| | P 1.0 | P 1.3 | P 2.0 | P 2.1 | P 3.0 | P 3.1 | P.5.0 | P5.1 |
|---|---|---|---|---|---|---|---|---|
| Stretching factor | 1 | 5 | 1 | 4.5 | 1 | 4.6 | 1 | 4.6 |
| Elastic | 982 | 3277 | 1572 | 3049 | 686 | 2189 | 873 | 1984 |
| modulus [MPa] | | | | | | | | |
| max strength, | 76 | 332 | 56 | 207 | 49.2 | 182.9 | 56.3 | 174.1 |
| σₘ [MPa] | | | | | | | | |
| max strain, | 189 | 9.1 | 88 | 11.8 | 233.5 | 23.6 | 267.7 | 46.0 |
| εₘ [%] | | | | | | | | |
| strength | 73 | 332 | 55 | 207 | 49.2 | 182.4 | 56.3 | 174.1 |
| at break, σ_{b} [MPa] | | | | | | | | |
| strain at | 181 | 9.12 | 102 | 12 | 234.2 | 23.9 | 267.7 | 46.0 |
| break, ε_{b} [%] | | | | | | | | |

TABLE 3
T = 23° C., results of the tensile tests according to Example 0

| | P 1.5 | P 1.6 | P 1.7 | P 1.8 |
|---|---|---|---|---|
| Stretching | 3.5 | 5 | 6 | 8 |
| factor | | | | |
| Modulus of | 3060 | 2030 | 1860 | 2856 |
| elasticity | | | | |
| [MPa] | | | | |
| Max strength, | 266 | 314.6 | 313.7 | 351.9 |
| σₘ [MPa] | | | | |
| Max strain, εₘ | 12.4 | 23.33 | 23.15 | 18.075 |
| [%] | | | | |
| Strength at | 266 | 308.5 | 308.2 | 351.9 |
| break, σ_{b} | | | | |
| [MPa] | | | | |
| Strain at | 12.4 | 23.35 | 23.16 | 18.075 |
| break, ε_{b} [%] | | | | |

TABLE 4
max strength, σₘ [MPa] for different testing
temperatures, results of the tests according to
Example 4, for samples with different stretching factors

| | P 1.0 | P 1.1 | P 1.2 | P 1.4 |
|---|---|---|---|---|
| Stretching factor | 1 | 1.1 | 2.5 | 4.7 |

| | σₘ | σₘ | σₘ | σₘ |
|---|---|---|---|---|
| Testing temperature [° C.] | [MPa] | [MPa] | [MPa] | [MPa] |
| 23 | 76 | 135 | 223 | 294 |
| 40 | 77.6 | 118 | 209 | 288 |
| 60 | 70 | 113 | 195 | 270 |
| 80 | 67.7 | 102 | 147 | 222 |

1. A stretched filament containing at least 80% by weight of linear, branched or cyclic, aliphatic or semiaromatic polyamides,
wherein the dry filaments have been stretched at a temperature between glass transition temperature and melting point and
wherein the filaments are cooled down in the dry state to below 100° C. under full tensile load, without using water for cooling.

2. The stretched filament according to claim 1, wherein the minimum stretching temperature T_{str,min} is determined with the aid of equation (1):
T_{str,min}=((Tₘ−T_{g})*X_{c})+T_{g} (G1)
where Tₘ=melting point, T_{g}=glass transition temperature and X_{c} is the crystallinity, and
wherein the crystallinity is determined by equation (2)
$${X}_{C} = \frac{Δ {H}_{m}}{Δ {H}_{m}^{0}} \qquad ( G2 )$$
where the parameters Tₘ, T_{g} and ΔHₘ are determined by DSC to EN ISO 11357-1:2016D and ΔHₘ⁰ is taken from standard tabular works.

3. The stretched filament according to claim 1, which have only low shrinkage/relaxation in the direction of tension when heated to a temperature above the glass transition temperature and below the melting point, preferably below the stretching temperature, a maximum of 6% in relation to the stretched length.

4. The stretched filament according to claim 1, wherein the monomers of the polyamides, aminocarboxylic acid or the lactam or a mixture of different monomers of this kind, have an arithmetic average of at least 7.0 carbon atoms, and in the case of a combination of diamine and dicarboxylic acid the arithmetic average of the carbon atoms of diamine and dicarboxylic acid is at least 7.0.

5. A method for production of the stretched filaments according to claim 1, wherein the filaments have been stretched at least by a factor of 2.5.

6. A composite comprising the stretched filaments according to claim 1.

7. A winding layer comprising the stretched filaments according to claim 1.

8. The stretched filament according to claim 2, which have only low shrinkage/relaxation in the direction of tension when heated to a temperature above the glass transition temperature and below the melting point, preferably below the stretching temperature, a maximum of 6% in relation to the stretched length.

9. The stretched filament according to claim 2, wherein the monomers of the polyamides, aminocarboxylic acid or the lactam or a mixture of different monomers of this kind, have an arithmetic average of at least 7.0 carbon atoms, and in the case of a combination of diamine and dicarboxylic acid the arithmetic average of the carbon atoms of diamine and dicarboxylic acid is at least 7.0.

10. The stretched filament according to claim 3, wherein the monomers of the polyamides, aminocarboxylic acid or the lactam or a mixture of different monomers of this kind, have an arithmetic average of at least 7.0 carbon atoms, and in the case of a combination of diamine and dicarboxylic acid the arithmetic average of the carbon atoms of diamine and dicarboxylic acid is at least 7.0.

11. A method for production of the stretched filaments according to claim 2, wherein the filaments have been stretched at least by a factor of 2.5.

12. A method for production of the stretched filaments according to claim 3, wherein the filaments have been stretched at least by a factor of 2.5.

13. A method for production of the stretched filaments according to claim 4, wherein the filaments have been stretched at least by a factor of 2.5.

14. A composite comprising the stretched filaments according to claim 2.

15. A composite comprising the stretched filaments according to claim 3.

16. A composite comprising the stretched filaments according to claim 4.

17. A composite comprising the stretched filaments according to claim 5.

18. A winding layer comprising the stretched filaments according to claim 2.

19. A winding layer comprising the stretched filaments according to claim 3.

20. A winding layer comprising the stretched filaments according to claim 4.
